(19) United States
(12) Patent Application Publication
(10) Pub. No.: US 2013/0033976 A1
(43) Pub. Date: Feb. 7, 2013

(54) STRUCTURE AND METHOD FOR GENERATING AN OPTICAL IMAGE FROM AN ULTRASONIC HOLOGRAPHIC PATTERN

(71) Applicants: Todd F. Garlick, McCook, NE (US); George F. Garlick, Richland, WA (US)

(72) Inventors: Todd F. Garlick, McCook, NE (US); George F. Garlick, Richland, WA (US)

(73) Assignee: ADVANCED IMAGING TECHNOLOGIES, INC., Richland, WA (US)

(21) Appl. No.: 13/198,553

(22) Filed: Aug. 4, 2011

(51) Int. Cl. G11B 7/00; G02B 9/12; B23P 17/00; G02B 27/20; H01S 3/067; G01N 29/04; G02B 27/46

(52) U.S. Cl. 369/103; 73/603; 359/784; 359/559; 362/259; 362/553; 29/527.6; G9B/7

(57) ABSTRACT

An acoustic hologram imaging system constructed from a machined housing having folded optics. Various surfaces of the housing are machined to provide a precise alignment to the optical members to be connected thereto, such as a mirror, a lens assembly, a light emitting laser diode, a camera, and the like. A three-part lens is described having different materials with different indexes of refraction in order to provide a desired focus of the light. In addition, an optical spatial filter is disclosed in which, according to various embodiments, all, some, or none of the light passing therethrough is attenuated for recording of the optical image of the hologram.

### BACKGROUND

1. Technical Field

This invention is in the field of optical image generation device and method and, more particularly, the generation of an optical image from an ultrasonic holographic pattern.

2. Description of the Related Art

The production of images using ultrasonic holography was pioneered several years ago by George Garlick. One of the patents he obtained in the area, U.S. Pat. No. 5,212,571, provides an explanation of his ultrasonic holographic imaging system.

FIG. 1, which is a copy from U.S. Pat. No. 5,212,571 to Garlick et al., shows the basic components of a prior art ultrasonic holographic imaging system 10. The holographic imaging system 10 is composed of two main subsystems, the ultrasonic holographic subsystem 14 which generates the acoustic hologram, and an optical subsystem 16 which transforms the acoustic hologram into an optical image which can be viewed by a physician, shown on a video display, or recorded in an image format, such as a picture. The ultrasonic holograph subsystem 14 passes acoustic waves through an object 12 to be examined. In one embodiment, the object 12 to be examined is human tissue, such as a breast for breast cancer detection. In other embodiments, the object 12 to be examined may be a fruit, a wood product, an article of commerce or other object where the interior is to be examined using acoustic waves.

The ultrasonic holograph subsystem 14 includes a transducer 18 which generates acoustic plane waves. The acoustic waves pass through a coupling medium 20 that is contained in a deformable membrane 22. The membrane 22 directly contacts the object 12 to be examined so the sound waves can efficiently pass into the object 12 with low attenuation. After the sound waves have passed through the object 12, they enter a liquid coupling medium 30 through a deformable membrane 24 which contacts the other side of the object 12, again, to reduce the loss of acoustic signal. The acoustic wave passes through a lens system 32 which, in some embodiments, includes two lenses 38, 40, but may include a different combination of lenses.

The lens system 32 focuses on a focal plane 34 within the object 12 to be examined. The sound wave then passes to an acoustic mirror 41 which reflects the ultrasonic energy at a selected angle, in this example 90°, in order to enter a hologram detection medium 36 contained within detection dish 44. An ultrasonic reference transducer 42 generates coherent ultrasonic plane waves at an angle with respect to the sensed waves reflected from acoustic mirror 41 and also impinges these acoustic waves on the hologram detecting dish 44 and the hologram detection medium 36.

The acoustic wave then enters the optical subsystem 16 where it is transformed into a visible pattern. The hologram detecting dish 44 contains a hologram detection medium 36 composed of a medium of a type that has been previously used in the prior art. The interference pattern created between the acoustic waves 41 that have passed through the object 12 to be examined and the coherent ultrasonic plane waves from transducer 42 creates a pattern at the hologram detection medium 36 which can be optically viewed.

In order to optically view the image at this hologram detection medium 36, a coherent light beam from a laser passes through a lens 45 and is reflected by a mirror 46 to pass through a lens 47. The illuminate image is detected via a pinhole filter 48 for viewing the image as reflected from the mirror 46. The filter 48 is used to completely block all but a desired diffracted order from viewing to enable a photographic film or a digital camera to record in real time the object 12 at the focal plane 34. The positioning of the aperture in the filter 48 will usually be positioned to permit viewing of the first diffracted order coming from the lens 47, although it can be positioned to view the second diffracted order or the zeroeth diffracted order. There are a large number of additional details to the structure and method of acoustic holograms that are all well known in the prior as described in this and other U.S. patents and these are therefore not explained in further detail.

After the ultrasonic holographic imaging system had been invented, George Garlick and others at his company continued to make improvements to the optical imaging portion of the optical subsystem 16, one improvement of which is shown in U.S. Pat. No. 5,179,455. Attached to the present application as FIG. 2 is a figure taken from this prior art '455 patent of which George Garlick is the inventor. According to this optical subsystem 16 from the '455 patent, a number of specific structures were provided in order to improve the viewing of the optical image.

As can be seen viewing FIG. 2 of the present application, the optical subsystem 16 includes a number of components. A container 88 has a hologram detection medium 36 in a tank containing fluid 30 as previously described with respect to FIG. 1. The fluid 30 is the same as that previously described with FIG. 1 and the object acoustic wave from the object 12 and the coherent beam acoustic wave from the generator 42 impinge upon the hologram detection medium 36 contained in the container 88. The collimating lens 86 is held perpendicular to the bottom surface 89 of the container 88 in order to detect holographic image pattern which occurs on the surface of the hologram detection medium 36. An optical tube 62 includes an upper portion 64 and a lower portion 66. The lower portion 66 contains the collimating lens mounted on mounting brackets 87 at a selected distance from the surface 92 of the liquid. A light source 74 is mounted on the translation stage 96 which is coupled to a fixture support 77. The fixture support 77 is sufficiently flexible that it can be controlled for precise movements in the X, Y, and Z directions by various knobs, not shown. The fixture 70 is coupled to a support plate 68 which is coupled to the optical tube 62. The entire optical tube 62 is supported by a pivot plate 56 which is connected to a support frame 54 to pivot about a horizontal axis 58.

The translation stage 96 contains an aperture 73, such as a lens or an aperture, to filter the light for viewing the hologram 94 on the surface of the hologram detection medium 90 through the collimating lens 86. The translation stage 96 is adjusted to align the appropriate diffracted beam order through the aperture 73, such as the 0 order, +1 order, −1 order, or other orders of the diffracted beams via the filter plate 72. An optical mirror 100 reflects the light so that it may be picked up by an appropriate viewing apparatus, such as a camera 80.

A camera 80 is mounted on the support plate 68. A mirror 99 receives the reflected beam from the optical mirror 100 and directs it toward the camera 80 to record the optical image or, in some cases, transmit it to a video display for live viewing by a physician.

While the improved system for optical reconstruction of the holographic image as described in the '455 patent provided some advantages over that used in the '571 patent, it still had a number of shortcomings. The optical tube 62 was relatively large, on the order of 3′-4′ in height. In addition, the quality of the collimating lens 86 permitted a minimum viewing area to be properly focused. For example, the collimating lens 86 may be in the diameter range of approximately 3″-4″ and, if extremely precise alignment and optical properties are used, a maximum diameter of approximately 5″ was attainable. George Garlick and others working with him have continued to make various improvements to the acoustic holograph system, some of which are shown in described in U.S. Pat. Nos. 5,084,776; 5,329,817; 6,702,747; 6,757,215; 6,831,874; and 6,860,855.

### BRIEF SUMMARY

According to the various embodiments described herein, an optical imaging system for providing a visual image of an ultrasonic hologram made of object under study.

The optical imaging system includes a lens through which light from a light source passes to illuminate the image and though which the image is recorded by a camera. The lens, light source and camera are all fastened to a common housing through which the light passes. The light source and camera are mounted on a common plate and move in unison as their position is adjusted. The lens is mounted spaced from the camera and light and adjacent the acoustic holographic image. The housing to which these are attached has a folded optical path with two mirrors that each reflect the light at a 90 degree angle and thus substantial reduce the height of the optical housing over what was possible in the prior art.

The optical housing is formed using a low-cost metal casting technique. The metal casting technique permits the mass production of the housing in large quantities at a low cost, but is not sufficiently precise to provide the alignment and positioning needed for the optical requirements of holography. Therefore, the cast housing has three major surfaces machined to a very high precision within tight tolerances with respect to each other. After the main housing has been machined, a first mirror assembly and a second mirror assembly are connected to it at the top sides. An optical plate is fastened at the bottom portion. A lens assembly and a spatial filter assembly are fastened to the optical plate, thus completing the optical assembly.

The use of folded optics, with two mirrors that reflect the image from the source to camera also provides an additional distance over which the image can be focused. This permits the use of a larger lens than was possible in the prior art, thus imaging a large area of the subject under examination.

Large lens are commonly not as high quality as smaller lens and to make a large single lens as precise as a small lens is much more expensive. Therefore, the use of a novel multipart lens provides a large lens that can take advantage of the use of the folded optic system. The ability to use a larger lens means that a new lens design was required that has capabilities beyond what was possible in the prior art.

According to one embodiment, the lens assembly includes a three different lens, all adjacent to each other, each having a different index of refraction. For example, the first lens may have an index of refraction of about 1.5, the next adjacent lens have an index of refraction of about 1.0 and the next lens have an index of refraction of about 1.8. Combined, they form a single lens that provides a larger surface area than was possible in the prior art with a single lens.

According to one embodiment, an optical spatial filter is provided that is positioned between the lens and the camera recording the hologram. The optical spatial filter may block all the zero order diffraction and permit only the +1 order to pass to the camera. Alternatively, it may permit the +1 and −1 orders to pass to the camera and block all other orders. Alternatively, the spatial filter may be composed of zones of varying opacity to permit some of the light to pass from each order and attenuate the light in each order so as to approximately normalize the amount of light the camera receives from each of the zero, first, second and third orders.

These advances provided an improved optical assemble for viewing an acoustic hologram over what was possible in the prior art.

### BRIEF DESCRIPTION OF THE SEVERAL VIEWS OF THE DRAWINGS

FIG. 1 is a schematic illustration of the operation of a prior art system taken from U.S. Pat. No. 5,212,571.

FIG. 2 is a cross-section of a prior art optical system taken from U.S. Pat. No. 5,179,455.

FIG. 3A is an isometric view of an optical section which incorporates features of the present invention.

FIG. 3B is an exploded view of FIG. 3A.

FIG. 3C is a cross sectional view of FIG. 3A, taken along the lines 3A-3A at a later stage in the manufacturing process.

FIG. 4 is a cross-sectional view of one embodiment of a mounting system for the lens in FIG. 3C according to one embodiment.

FIG. 5A is a schematic illustration of a light illumination system according to the prior art.

FIGS. 5B and 5C are light illumination systems according to various embodiments that incorporate some features of the present invention.

FIGS. 6A-6D illustrate various optical filtering techniques which may be used as alternative embodiments in various features of the present invention.

FIG. 7 illustrates one potential embodiment for a mounting system of a camera and light according to one embodiment of the present invention.

### DETAILED DESCRIPTION

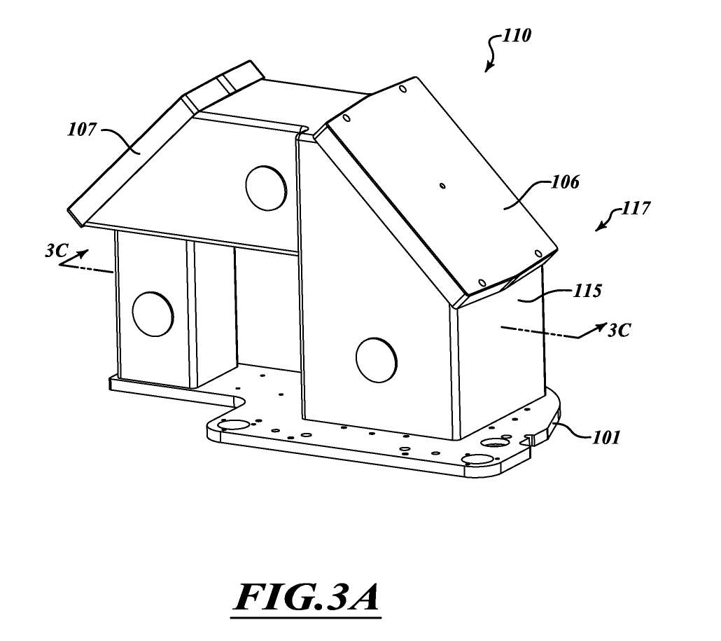

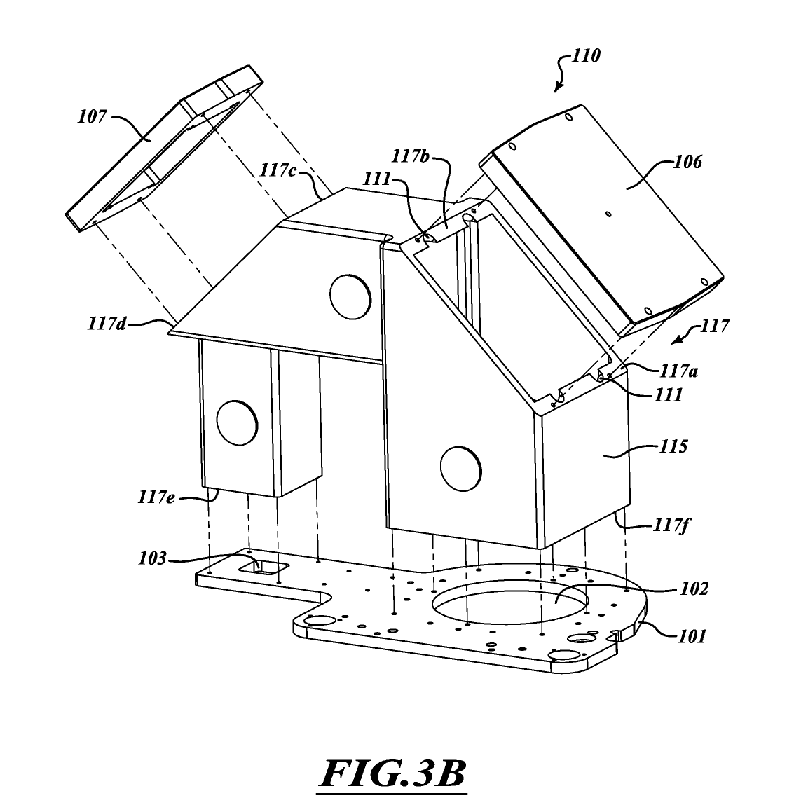

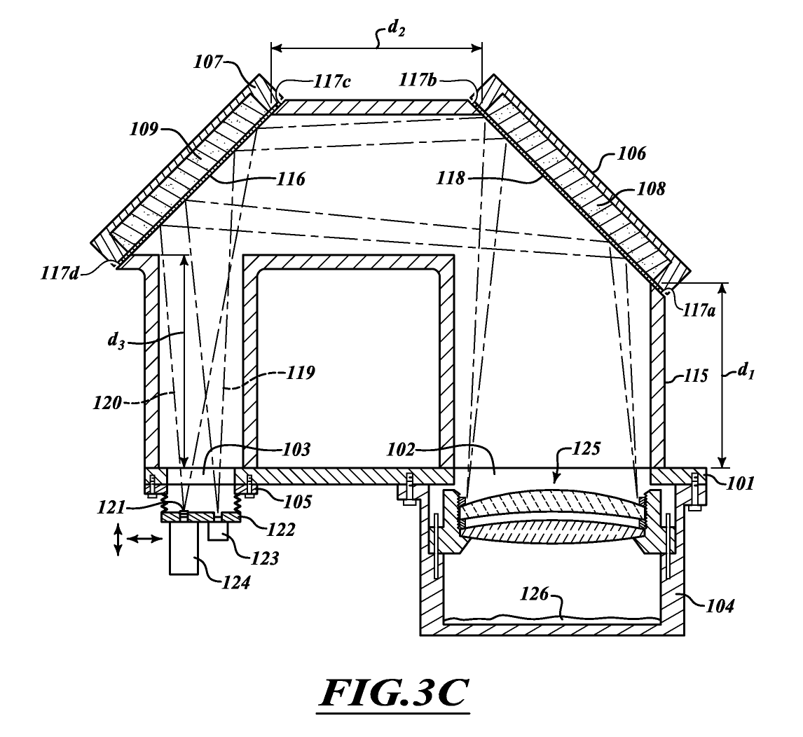

FIG. 3A is an isometric view of an optical assembly 110 which includes a number of embodiments of the present invention and various features. The optical assembly 110 includes a housing 115 which contains precision machined surfaces 117 (see FIG. 3B). The precision machined surfaces, generally referred to as 117 include placement locations for a collimating lens assembly 125, a first optical mirror 118 and a second optical mirror 116.

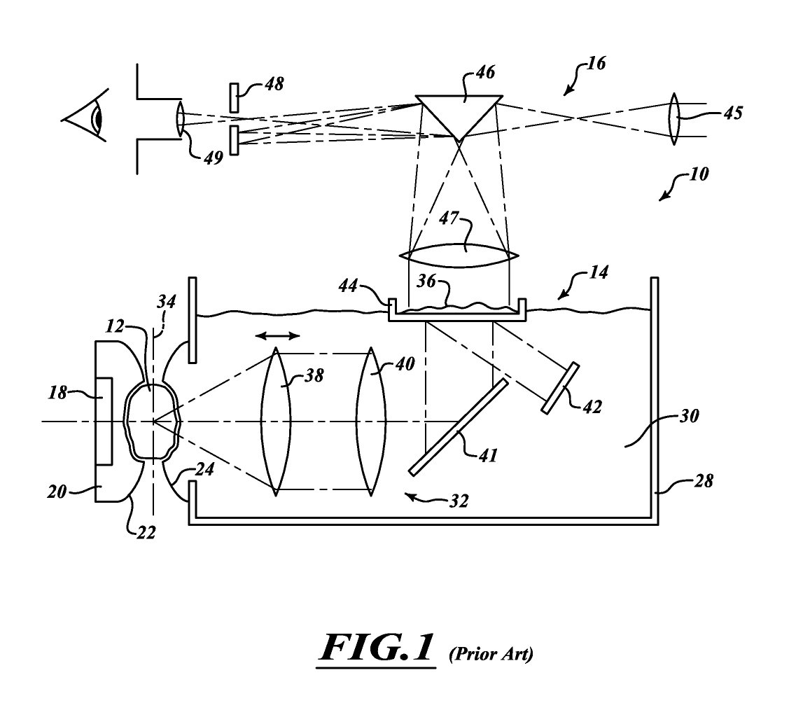

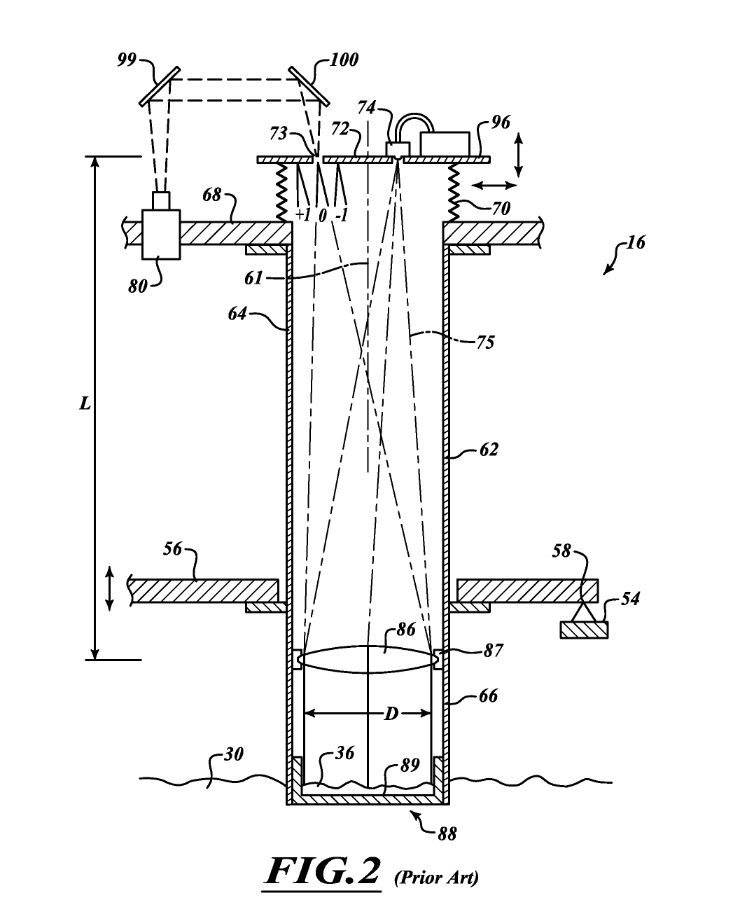

The optical assembly 110 is in the form of a folded optics system. The housing 115 is a sealed cap system which is made from a single metal cast housing. In a preferred embodiment, housing 115 is a single piece, unitary aluminum cast housing. Of course, the housing can be made of other types of material including high density plastics, steel, or other materials which can provide a sealed housing for precise mounting of optical instruments. The folded optical housing 115 has a significantly lower profile than the optical housing of the prior art as shown in FIG. 2, as one example. In the prior art, the total height of the optical housing is generally in the range of 3′-4′ tall and substantially adds to the bulk of the system as a whole. The use of a folded optical housing 115, as illustrated in FIG. 3A, provides an entire optical assembly 110 which is less than 15″ high and preferably is in the range of 10″-13″ high. The width of the optical assembly 110 is, of course, substantially wider than that of the prior art optical housing. Since the acoustic tank 28 is quite wide, see FIG. 1, having a wide optical housing more accurately matches the width of the other components and does not add to the footprint of the system. Thus, the folded optical system according to one embodiment of the present invention is approximately 13″ in height and 20″ in width.

The housing 115 is constructed by a low-cost, dual-step process so that it can be mass produced with high precision of all components to tight tolerances. In a first step, the housing 115 is created as a single piece cast in a mold. A metal mold casting can be made in a mass production system for low cost. Accordingly, the use of a metal casting mold for the first step in making the housing 115 provides the benefit of mass production of the housing at a low cost. Following the production of the cast housing 115, the precision machined surface 117 to which the individual components will be mounted to the housing 115 are precision machined using a computer-driven machining tool in order to obtain an end product which has very precise features within tight tolerances.

One technique for the manufacture of the optical assembly having a single piece cast housing, will now be explained.

As can be seen in FIG. 3A, the optical assembly includes a single piece cast housing 115. An optic plate 101 is affixed to the bottom surface of the cast housing 115 after it has been machined. Mirror assemblies 106 and 107 are fastened to the cast housing 115 after it has been machined. The method of making the optical assembly 110 will now be described from an overview standpoint, highlighting the salient features that provide particular advantages.

Unfortunately, standard aluminum casting does not permit a product to be made with sufficient precision that is needed for the mounting of the lens and the mirrors for use in the present invention. Accordingly, the aluminum cast housing 115 is then further machined in a precision computer-driven machining tool.

A computer-driven three-axis CNC milling machine is used to precisely mill the precision machined surfaces 117 as needed to hold the respective components. A standard three-axis CNC milling machine may be used of the type commonly available in the art. After the aluminum cast housing 115 is completed, it is slightly larger in the dimensions d1, d2 and d3 for that some material can be machined away to form the precise final assembly. The housing is placed in a CNC milling machine which has been programmed with the appropriate dimensions required to be precision machined into the specific bracket starting from members 117a-117f. The CNC milling machine therefore mills a surface to receive the collimating lens assembly 125 that is a precise distance from the hologram detecting medium 126 and from the mirror 118. It also mills the housing 115 to form the support surfaces 117a and 117b to hold the mirror 118 which have a precise relationship with respect to each other for retaining the mirror 118 at an exact angle relative to the rest of the housing 115 and a distance d1 relative to collimating lens assembly 125. Similarly, it machines surfaces 117c and 117d to hold second optical mirror 116 at a precise angle and at an exact distance from mirror 118. Similarly, surfaces 117e and 117f are machined to a precise flat shape and at precise locations and sizes.

The use of a combination aluminum cast housing followed with milling of a few of the key surfaces provides a low-cost, high-volume production technique for achieving an optically precise housing 115. Only a few different housing surfaces need to be machined, such as 117a-117f. With only a very few surfaces to be precision machined, the CNC machine can work very quickly and, in a short period of time, produce a single precision shaped housing 115. The other components in the housing are fastened as explained herein. These dimensions are sufficient to perform high quality optical function of the optical assembly 110. Accordingly, the inventors recognize that only a few critical components of the housing 115 needed to be precision machined with respect to other components and thus saves considerable time and money by machining only those necessary components and not the entire housing 115.

After the precision machined surfaces 117 have been machined by a CNC milling machine, the optical components 125, 118, 116 are mounted therein using standard attachment techniques, such as brackets and fasteners. Because of the precision machining, the mirrors 118, 116 and optic plate 101 can be placed in abutting contact with precision machined surfaces 117 formed to receive them and no further adjustment is needed. The alignment is sufficiently precise from the CNC milling to ensure that the alignment is accurate within acceptable tolerances without any individual adjustment or manipulation of each component.

A standard worker with assembly skills can therefore assemble the housing without the need for special skills and training in optics, precise alignment techniques and without precise alignment tools, which are very expensive. In the prior art the mounting bracket 87 for the collimating lens 86 had to be particularly adjusted for each individual system taking many hours and a great deal of effort for precise alignment for each individual optical imaging system that was constructed, whereas with the present invention, by placing the collimating lens assembly 125 in the precision machined surfaces 117 correct alignment is automatically ensured. Accordingly, the optical housing can now be made in high-volume production mode in a two-step process that is very fast and low cost.

According to one embodiment, the housing 115 is cast as a single piece metal housing, preferably composed of aluminum, although other metals are acceptable. The housing 115 contains a number of precision machined surfaces referred to as 117 as a group, that are constructed to have specific distance and angle relationships to each other.

As can be seen in FIGS. 3B and 3C, the housing 115 includes a number of surfaces which must be precisely formed relative to each other. A precision surface 117a is provided at an exact angle relative to 117b and also positioned an exact distance from a first surface 117e. As can be seen in FIG. 3C, the opening at surface 117a is also positioned an exact distance d1 from the bottom surface 117e of the housing 115.

Unfortunately, the casting process does not permit the formation of a single cast member with sufficient precision to provide the optical properties needed for the holographic optical assembly 110. In order to solve this problem at a low cost, the housing 115 is cast as a single piece having as close to possible the final shape to be desired, with the realization that some additional machining would be required. The housing 115 is therefore made slightly taller than the final dimension to permit machining to occur to form the precise surfaces. It thus is slightly larger than would be required in the final shape, so that after machining and the removal of material the distances will be exactly as desired. Following the casting, the housing 115 is precision machined to form the surface 117a an exact distance d1 from the bottom surface 117e. In addition, the precise angle of the surface 117a is machined to be exactly that angle necessary to abut mirror 118. Similarly, the surface 117b is machined to be exactly flat and have the exact angle relative to 117a to exactly match the angle needed to support mirror 118 to provide the optical properties and reflection angle needed in illuminating and recording the hologram in hologram detecting medium 126. Similarly, the surfaces 117c and 117d to which the second mirror assembly 107 is to be affixed are precision machined to have exact distances d2 and d3 from other portions of the housing 115 and also to be at a precise angle so that second optical mirror 116 is precisely mounted as required for the optical properties to detect the hologram. The bottom surfaces 117e and 117f are also precision machined in order to obtain the exact distances d1 and d3 as shown in FIG. 3C, and also to be exactly flat for properly abutting with the optic plate 101.

The other portions of the optical assembly 110 are made in a similar manner to that which has been described for the housing 115. Namely, the other significant portions of the optical assembly 110 include the first mirror assembly 106, the second mirror assembly 107, the optical mirror 100, the lens assembly 104, and the light and recording assembly 105. Each of those are within housings which are first cast and then precision machined so as to exactly match and mate with the other machined parts so that when final assembly is carried out each of the pieces will be precisely aligned with respect to each other and alignment of each individual optical assembly 110 for each individual machine is not required.

As shown in FIGS. 3B and 3C, the assembly will be further explained. After the housing 115 has been properly machined to the exact dimensions and tolerances needed, a first mirror assembly 106 is affixed to a first surface of the housing 115 to abut with machined surfaces 117a and 117b. Apertures 111 are formed in the various surfaces to hold the brackets that support the mirror 118 as explained later with respect to FIG. 3C. The second mirror assembly 107 is also attached to the housing 115 to abut with surfaces 117c and 117d in a manner similar to that described with respect to first mirror assembly 106. The optic plate 101 contains apertures 102 and 103 to receive the lens assembly 104 and the light and recording assembly 105, as explained later herein.

FIG. 3C is a cross-sectional view taken generally along the lines 3C-3C from FIG. 3A at a later stage in the assembly in which the lens assembly 104 and the light generation and recording assembly 105 have been affixed to the optical assembly 110. FIG. 3C illustrates that the lens assembly 104 is bolted onto the optic plate 101 after the optical plate has been attached to the housing 115. The precise fasteners and attachment mechanism for affixing to the housing 115 are not shown in FIG. 3C for simplicity's sake but standard fastening techniques will be used as known in the art and as illustrated in FIG. 3B. Similarly, the light generation and recording assembly 105 is fastened to the optic plate 101 using the appropriate fasteners. Each of the mirror assemblies 106 and 107 are composed of various parts in order to provide the respective mirrors at a precise location for each housing that is assembled. As can be seen in FIG. 3B, the respective mirror assemblies 106 and 107 contain recess cavities in order to receive portions of the mirror assembly. Inside the recess cavity a supporting foam 108 is provided in the first mirror assembly 106 and a foam 109 in the second mirror assembly 107. The foam backing has a slight spring and is slightly thicker than the aperture in which it is affixed and therefore, when not compressed sticks slightly out of the aperture. During the assembly process, the mirror 118 is pressed against the foam 108 and the foam 108 is compressed until the mirror 118 is pressed flush against the outermost surface of the edges of the mirror assembly 106. Retaining brackets, two at the top and two at the bottom, are then fastened in position in order to hold the mirror 118 firmly in position flush against the edges of the mirror assembly 106.

The brackets which hold the mirror 118 in position are of a type well known in the art for fixing pictures into frames, as one example. One example of these are brackets which are fixed in place by fasteners, such as screws, which can be loosened so that the brackets can be rotated out of position, with the retaining portion of the bracket away from the mirror. The mirror is then placed in position and pressed to compress the foam 108. The brackets are then rotated back into position and threaded tightly against the mirror to hold the foam fully compressed and the mirror in a flush position against the mirror assembly 106. Since the brackets will extend slightly out of the mirror assembly 106, apertures 111 are machined into the housing 115 to receive the brackets which hold the mirror in position, and they therefore do not interfere with the precise fit that the mirror has with the housing 115. The back side of the mirror 118 is therefore held flush against the flange edges 106a and 106b. In a similar manner, the second optical mirror 116 is held flush against the flange edges of mirror assembly 107.

After the respective mirror assemblies 106 and 107 have been completed having the mirrors 118 and 116 properly affixed thereon and flush against their surfaces, they are then ready to be fastened to the housing 115. The mirror assembly 106 is then fastened to the first exposed location by placing the mirror 118 in abutting contact with the machined surfaces 117a and 117b. Since the mirror itself abuts directly against the surfaces 117a and 117b, the exact location of the mirror including its angle, orientation, and distance will be precisely known based on the machining of the housing. Appropriate fasteners are thereafter attached in order to hold the first mirror assembly 106 onto the housing 115 as shown in FIG. 3B. In a similar manner, the second mirror assembly 107 is attached to the housing 115 so that second optical mirror 116 abuts against the housing 115 and is held in a precise relationship according to the machining process which has taken place.

As can be seen in FIG. 3C, hologram detecting medium 126 is positioned in a bottom surface of the housing and corresponds to the hologram detection medium 36 and 90 as shown in FIGS. 1 and 2. The acoustic hologram is generated by any acceptable technique similar to that shown in FIG. 1 or any of the prior patents which disclose various techniques for creating the acoustical image which have been disclosed in the background and are incorporated herein by reference. Once the acoustic holographic pattern of the object 112 being imaged is present on the hologram detecting medium 126, a coherent light 119 from laser diode 123 passes through aperture 127 and is reflected onto second optical mirror 116 to mirror 118 and through the collimating lens assembly 125. The hologram detecting medium 126 is therefore illuminated with a coherent beam of light so that the pattern may be viewed with the appearance of being a hologram. The image is picked up and recorded by camera 124 mounted on translation stage 122 which views the image through optical spatial filter 121 as an optical image as it is received through the collimating lens assembly 125, reflected from mirror 118 and second optical mirror 116 and passes through aperture 128. The translation stage 122 is movable in three dimensions using techniques known in the prior art for precise movement of such stages.

In the optical assembly 110, the same translation stage 122 holds both the light source 123 and the camera 124. Accordingly, any changes in the angle and location at which the light leaves the stage 122 will be accompanied by changes in the camera 124 so that the two optical devices, the laser diode 123 and the light collector 124 will always have a precise relationship relative to each other. This provides significant improvement in the quality of the recorded image as the stage 122 is moved in different directions via precision micrometer adjustments.

The light and recording assembly 105 contains two light instruments, the laser diode 123 and the camera 124. Both of these are mounted to the same stage 122 in a precise and known relationship relative to each other providing significant advantages over that which was provided in the prior art. As noted in the prior art of FIG. 2, the camera 80 was mounted on a support plate 68 which held the optical tube 62 and the light source 74 is mounted on a translation stage 96 which could move in three dimensions in order to align the aperture 73 with the desired light beam pattern coming from collimating lens 86. According to one embodiment of the present invention, the stage 122 ensures that the light which is emitted by the laser diode 123 is reflected off the same mirrors and passes in a fixed relationship relative to the camera 124 at all times. Namely, if the stage 122 is moved to adjust the angle at which the camera receives light, the laser diode 123 will also move slightly in order to modify the receiving of the light. This provides significant simplicity in assembly and ensures consistent illumination of the hologram at hologram detecting medium 126 over that which was possible in the prior art.

The stage 122 is movable using the same techniques and assemblies that were used to move the translation stage 96 in the prior art. Generally, the movements are quite small, in the millimeter or smaller range. Stage 122 can move in different directions via precise micrometer adjustment. Commercially available micrometers are well known and can be affixed to the stage for precise positioning within millimeters and fractions of millimeters. A travel range of approximately 10-12 millimeters is acceptable for the stage 122 in order to properly align the camera 124 at the various locations desired.

In one embodiment, the collimating lens in the collimating lens assembly 125 is a single lens of a type used in the prior art mounted a precise distance from the hologram detecting medium 126, see, for example, U.S. Pat. No. 5,179,455, collimating lens 86 and mounting bracket 87.

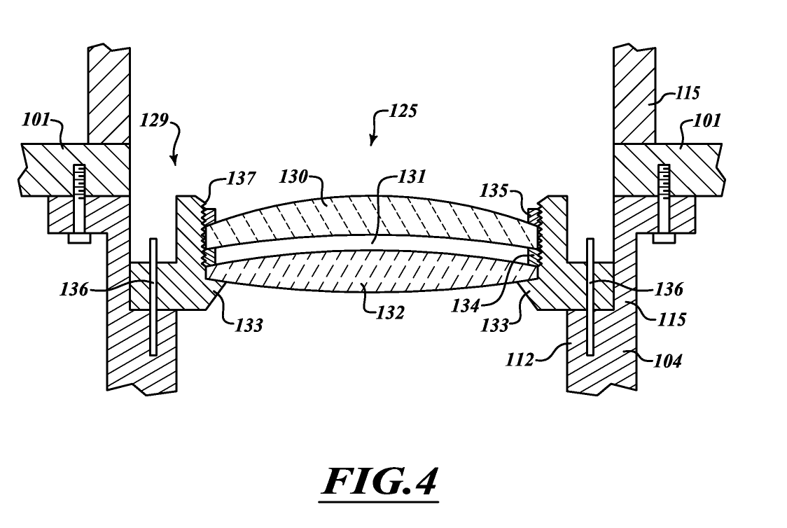

FIG. 4 illustrates an alternative embodiment for a lens according to further principles of the present invention. In a preferred embodiment of a lens of the present invention, the collimating lens assembly 125 includes two, three or more lens layers responsible for focusing the coherent light 119 and the optical beam 120.

In the embodiment shown in FIG. 4, the collimating lens assembly 125 includes three distinct lens layers. A first layer 130 is a transparent medium, preferably of a type of flint glass, with an index of refraction generally on the order of 1.8. The curvature and shape of this first lens 130 is selected to provide the final shape and focus needed for the image to be viewed by the camera 124. Layer 131 is a transparent medium with an index of refraction which is substantially lower than that of the flint glass, for example, air, a pure vacuum, a noble gas such as argon, or other medium having a low index refraction approximately equal to 1.0. The curvature of the layer 131 conforms to the curvature of the back surface of lens 130 as it abuts with the surface of lens 130 and lens 132 adds further to the bending of the incident beam.

A third lens 132 is also provided as a transparent medium, preferably of a type of crown glass, with an index of refraction generally on the order of 1.5. The shape and position of the third transparent medium 132 is selected to provide a first forming of the image on the hologram detecting medium 126.

The exact index of refractions and specific shape of the lenses in the collimating lens assembly 125 will be based on a number of factors including the distance to the hologram detecting medium 126, the total optical length from the lens to the camera 124, and other factors. Thus, while the first lens 130 will have an index of refraction approximately of 1.8, according to various embodiments the index refraction will extend or range from 1.62 to 1.9, and preferably is in the range of 1.7 to 1.85. The second lens will have an index of refraction which extends over the range of 1.0000 to 1.05, although in most instances it will generally tend to be within the range of 1.001 or less. The third lens 132 will generally have an index of refraction that extends over the range of 1.42 to 1.59 with a preferred index of refraction range of between 1.48 and 1.52.

These three separately formed layers are mounted in a precision lens mounting assembly 129 which provides a registered surface 133 having a precisely machined distance from the hologram detecting medium 126 of the precision housing assembly 104. These three separate layers are mounted in the precision lens mounting assembly 129, which provide registered surface 133 and a precision spacer 134 and a final environmental seal 135 which is held in place by a precision fastening ring that is threaded onto the seal 135 to hold it in position.

The collimating lens assembly 125 can be constructed of three types of glass instead of one lens having air or a vacuum. Alternatively it may be four lens layers, three of glass and one of air, or five layers, of various combinations of glass or air.

This precision lens mounting assembly 129 is constructed from a single piece of cast aluminum that is machined using a precision three-axis CNC milling machine of the type previously described with respect to forming the housing 115. In particular, the precision lens mounting assembly 129 is first cast as an aluminum or other metal housing a metal casting form. It will generally be cast as an annular assembly having tolerances as reasonable as can be obtained using aluminum mold casting. The precision lens mounting assembly 129 is then placed in the CNC milling machine so that the various surfaces may be precision milled with respect to each other. The retaining bracket 133 is milled to a precise shape and having a specific distance from the bottom surface 137 of the precision lens mounting assembly 129. Apertures 136 are also machined at a precise location relative to the bracket 133.

After the milling work is completed, the lens 132 is placed into the aperture 128 and fastened to tightly abut the bracket 133 along a registered surface. A precision spacer 134 is then inserted. Preferably, the precision spacer 134 is an annular shape, to match the exact annular dimensions and shape of the optical lens 132. It can be threaded on threads 137 or placed by any acceptable technique. It contains threads of a precise shape and count number to lock the lens 132 in a known location and also provide precise spacing for lens 131 and 130. After the precision spacer 134 is placed, then the optical lens 130 is placed in abutting contact with the precision spacer 134 along the registered surface and fixed in an exact location. The precision spacer 134 ensures that the optical lenses 132, 130 will be precisely mounted an exact distance from each other and with an exact relationship relative to each other to form the air lens 131 of a desired dimension, location and shape.

After the lenses 132, 130 are mounted, the interior space between them can be filled with the appropriate gas, such as air, argon, or other acceptable gas. In one embodiment, the assembly of collimating lens assembly 125 is performed in ambient air that is sufficiently clean and dust free that the local ambient air present at assembly is within the lens chamber 131. In some embodiments, the interior region between the lenses is pumped to a vacuum of very low torr, for example, in the range of 1 to 5 torr. The pumping of a vacuum between the lenses provides the benefits of removing all potential for dust or impurities which may exist between them and also confirming that the two lenses are held a specific relationship relative to each other as determined by the spacer 134 because the vacuum will draw the lenses tightly toward each other to perform a precise registration with respect to the spacer 134. After the appropriate gas or vacuum has been placed in lens space 130, a hermetic seal ring 135 is applied to retain an airtight seal around the entire optical assembly. If desired, a similar airtight seal bracket 135 may also be applied at the lower registration surface 133, although this is not needed in most embodiments because the precision formation surface 133 will be sufficient to ensure a hermetic seal with the lens 132. After the sealing collar 135 is applied, a retaining ring, not shown, is threaded into the machine threads 137 which are provided on the precision lens mounting assembly 129 to hold the lens in the preset orientation.

After the collimating lens assembly 125 is completely assembled, it is placed in the previously machined housing 104 using apertures 136 to align with rods that have been placed with precision in the housing 104. The rods would be of a type that extend upward from the bottom bracket and have been formed as part of the formation of 104 in a manner similar to that described above.

This alternative lens and technique as shown in FIG. 4 for mounting the lens provides the benefit that the lens assembly can be precision constructed separate from the housing assembly and then the two assembled in a precision arrangement with a very simple process by fastening the housing 104 onto precision surface optic plate 101 under surface 117f.

A three-part optical lens assembly provides significant advantages over those which were possible with a single collimating lens 86 previously used in the prior art. One of the keys to improve success in medical imaging is to increase the field of view. For example, when a human tissue is being examined for a medical diagnosis, a larger field of view permits a substantially larger amount of tissue to be examined at one time. A single large image of the entire area thus increases greatly the understanding of the physician when looking at the object 12 under examination. Furthermore a larger field of view greatly decreases the examination time as well as the time it takes a physician to read the results since a single image can be viewed where with the prior art multiple images may be required to be viewed simultaneously. In the prior art, a lens in the 3″ diameter range was quite common since larger single lenses having sufficient optical properties are difficult to form and very expensive. With substantial expense, time, and effort, the prior art was able to make use of a single lenses in the range of 4″ which had sufficient quality for viewing the ultrasonic holographic image. However, 5″ was the maximum limit by which a lens could be made with sufficient precision to view the features of the object being formed. Any larger lens would have excessive distortion and did not provide sufficient precision in the optical properties because the ray of light must be bent by one lens from its furthermost edge to the center. However, a lens made according to principles of the present invention can be made in the 8″ diameter range and provide a clear optical image of the entire hologram, and thus greatly increase the field of view of the tissue to be examined.

According to the embodiment of FIG. 4, each of the lens surfaces performs a minor part of the bending function, with a first lens 130 preforming a first bending of the light, the second lens 131a second bending, and the final lens 132 the third bending, so that each lens contributes a lesser amount to the bending of the light than was done in the prior art, but the lens assembly as whole is able to bend the ray of light over a greater distance with even more precision than was possible with a single collimating lens of the prior art.

A larger field of image in the range of 6″-8″ in diameter provides a much more efficient viewing of the object 12, particularly if larger portions of human tissue are being imaged, such as the entire abdomen area, the lungs, the heart, or other regions.

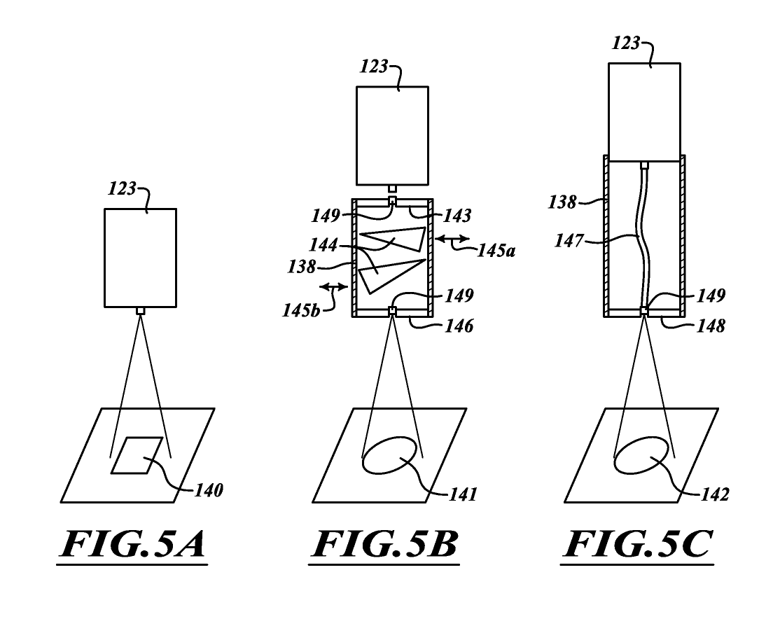

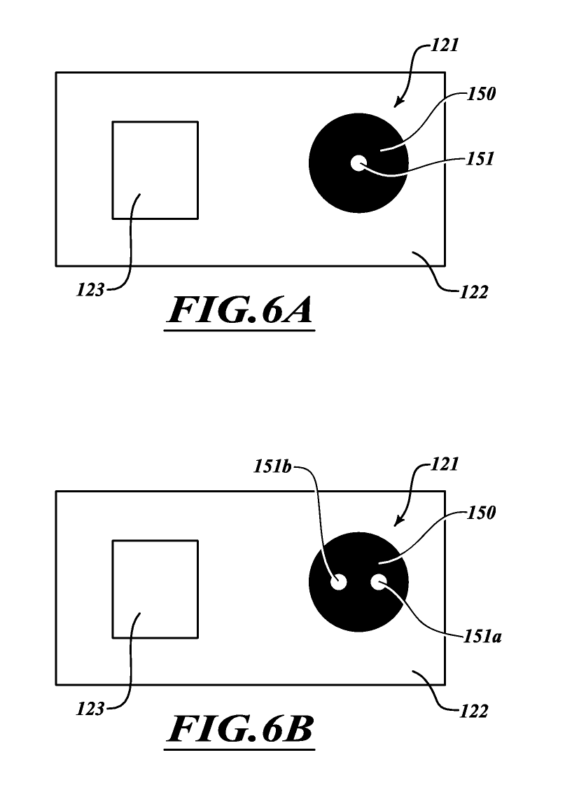

FIGS. 5A-5C illustrate another embodiment according to principles of the present invention. Preferably, the optical source as used in the present invention has a novel and unique beam conditioning system which greatly improves the image quality over that available in the prior art. FIG. 5A illustrates a prior art optical source of the type commonly used. As is known in the prior art, a laser diode is constructed from two or more layers of semiconductor material. For a bright beam, a plurality of layer pairs are laminated and the light is emitted from the edge of the many laminated layers. This results in a light source which is rectangular in shape and may, in some instances, have bands of slightly different light intensity within the beam. Thus, a standard laser diode emits a rectangular beam profile 140 due to the rectangular shape of the light forming surface of the laser diode 123. Furthermore, the rectangular shape may also have various diffraction patterns which are further enforced by the coherent nature of the light source. These diffraction patterns may also result in slightly different intensities of the light across the width of the entire beam. When used in an imaging application these diffraction patterns are manifest as slightly darker and brighter bands across the image. This results in overexposing some areas and underexposing others. This often results in an inconsistency when interpreting the image. Accordingly, the inventor has realized that some improvements can be made to the light source to make the source more uniform and to more closely match the shape of the holographic pattern which is being created by the acoustic wave.

FIG. 5B shows a first embodiment of an improved light source 141 according to principles of the present invention. In the first embodiment, the laser diode source 23 is conditioned at the point of being emitted from the diode using a plate 143 having a microaperture 149 having a circular shape. The aperture 149 may include an optical lens, or it may be a circular hole of a precise shape in the shaping plate 143. After the light is emitted through the plate 143, two opposing microprisms 144 further circularize the light to transition the rectangular beam into a round optical shape that matches the round shape of the collimating lens assembly 125. The two opposing microprisms 144 can be adjusted along various axes 145a and 145b with respect to each other in order to transition the light from a generally rectangular beam so that it exits the prism 144 as a circular beam of light. As the light exits the microprisms 144, a further shaping plate 146 has a microaperture 149 formed therein in a circular pattern to further filter the light and assist in forming a circular beam. The microaperture 149 may or may not have a microlens mounted therein, depending on the desired design and focus of the light for a particular embodiment. The use of two shaping plates 143, 146 with beam-forming structures 144 in between the plates to transition the shape of the laser diode beam pattern from rectangular to circular provides a significant advantage to provide circular coverage of the light source over the entire surface of the acoustic hologram to be imaged through the collimating lens assembly 125 and also uniform light intensity over the entire circular pattern.

FIG. 5C shows an alternative embodiment for forming a circular pattern for light emitted from a laser diode 123. According to the alternative embodiment of FIG. 5C, the rectangular light pattern exiting the laser diode 123 is input directly to a high-quality fiber optic cable 147 that is circular. The high-quality fiber optic cable 147 conditions the light to transform it into a more circular profile than the rectangular profile in which it was created. At the exit of the fiber optic cable 147, the light passes through a shaping plate 148 having a circular aperture 149. The aperture 149 may or may not have a microlens positioned therein. The circular aperture 149 will further condition the beam to eliminate diffraction effects and provide uniform distribution of the light intensity in a circular pattern.

In some embodiments, the design of FIG. 5C is preferred because of the ease of manufacture and low cost. In other embodiments, the design of FIG. 5B is preferred to provide a higher quality light source with greater final intensity, more uniformity, and more circular than can generally be obtained from a fiber optic cable 147.

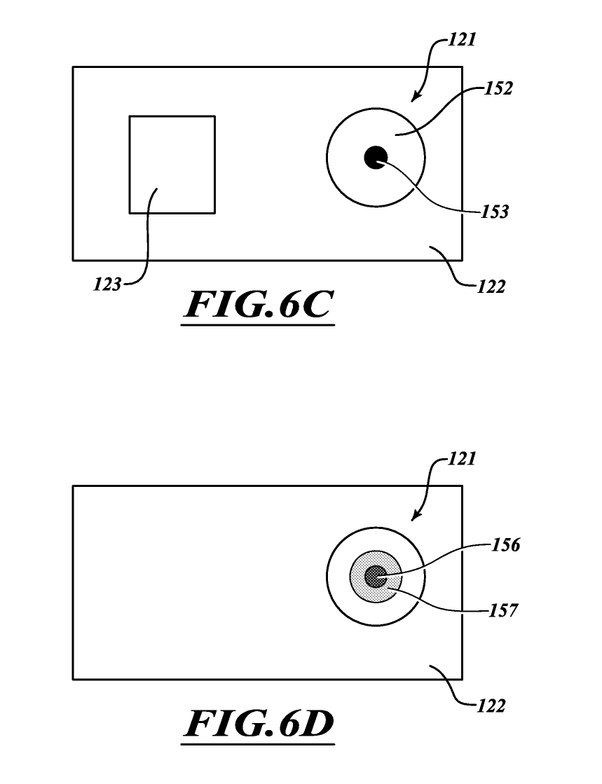

FIGS. 6A-6D illustrate various embodiments for viewing the optical image and recording it via camera 124. The optical spatial filter 121 is located on the optical housing translation stage 122 and is adjacent to the laser diode 123. The optical spatial filter 121 includes a variety of interchangeable disks comprising various regions which are 100% optically transmissive, partially optically transmissive, and fully optically blocking. Various embodiments of possible optical filters will now be described.

As can be seen in FIG. 6A, the translation stage 122 has an optical spatial filter 121 positioned between the light that illuminates the hologram detecting medium 126 and recording camera 124. FIG. 6A illustrates a first embodiment for an optical spatial filter 121 to record the image. According to this first embodiment, the filter includes a dark region 150 to block the light of selected portions of the image and an aperture 151 through which the light can pass at selected portions.

The optical spatial filter 121 is located on the optical housing translation stage 122 and is adjacent to the laser diode 123. The optical spatial filter 121 includes a variety of interchangeable disks comprising various regions which are 100% optically transmissive, partially optically transmissive, and fully optically blocking. Various embodiments of possible optical filters will now be described.

According to a first embodiment, the area 151 is fully optically transmissive to pass 100% of the light received at the region 151 and the dark region 150 is full opaque. The user may move the translation stage 122 using the appropriate mechanism in order to align the aperture 151 to the desired diffraction order of the image to be received. An optical image of the ultrasonic hologram appearing at hologram detecting medium 126 will include various order of the component. This includes the 0 order component, the +1 and −1 order components, the +2 and −2 order components, the +3 and −3 order components, and so on. The 0 order diffraction is by far the strongest and contains the largest amount of light. In most instances, the 0 order will be so bright as to over whelm the other orders and make viewing a +1 order and −1 order difficult.

In FIG. 6A, an example is provided in which only one order, for example the +1 order, is permitted to pass and all other components, including the 0 order component and the −1 order, are blocked. According to this embodiment, the aperture 151 is positioned to be aligned exactly with the location of the +1 order component of the optical beam 120 and block all other orders.

The user can move the translation stage 122 to receive and record other orders of the image at different times, for example, the aperture can be positioned to receive and record the 0 order component during a first time period, the −1 order component during a second time period, the +2 order component, respectively, and so forth. The filter of the type shown in FIG. 6A provides the advantage that a particular desired component may be specifically studied and all other components blocked as the image is recorded by the camera 124.

FIG. 6B illustrates another embodiment of the present invention for the optical spatial filter 121. According to this embodiment, two apertures 151a, 151b are provided and the remainder of the dark region 150 has an opaque blocking member present. With the use of two apertures 151a, 151b, two orders can pass simultaneously for recording with camera 124 having the principle advantage that this embodiment will effectively double the higher dynamic range with the greater quantity of light that's passing through the filter. For example, the spacing of apertures 151a, 151b can be selected to permit the +1 and −1 orders to pass through the filter at the same time. Both orders of diffraction are recorded, thus obtaining more information and requiring less ultrasonic power to create the initial acoustic image of hologram detecting medium 126. In one embodiment, a microlens is used in one of the two apertures to align the light from the two different orders of diffraction to provide a conjugate of one order as information from both orders are recorded by camera 124.

FIG. 6C illustrates another embodiment for the optical spatial filter 121. According to this alternative embodiment, the 0 order diffraction component is completely blocked and all other orders are allowed to pass. A filter according to this embodiment places an opaque member 153 at a central location of the optical spatial filter 121 and all other portions of the filter 152 are transparent to light. The central portion having the opaque member is selected to completely block all light contained in the 0 order of the diffraction. In this embodiment, the translation stage 122 is positioned to align the opaque member 153 with the 0 order diffraction of the recipient beam to block all light contained in the 0 order. All light from the other orders, including +1, −1; +2, −2; and +3, −3; etc. are received and recorded by the camera 124.

The principle advantage of the configuration of FIG. 6C is the ability to capture actual hologram pattern information. Such a filter provides blocking of the highlight intensity of the 0 order sufficient that all the other diffractory orders may be recorded even though they have significant lower intensity. Without a filter that blocks the 0 order diffraction beam, the camera 124 may have overexposure or blooming which makes recording of the image difficult and also makes recording of the other weaker, diffracted images difficult or impossible. Once the hologram pattern has been captured using a filter of the type shown in FIG. 6C, the image can be reconstructed computationally and selected software filters applied to remove image artifacts and create an image that more accurately reflects the created acoustic hologram.

FIG. 6D illustrates yet another alternative embodiment according to one of the inventive features. FIG. 6D utilizes an optical spatial filter 121 in which none of the blocking patterns are completely opaque. Rather, each of the blocking patterns permits some amount of light to pass therethrough. The lens will attenuate a portion of the light so as to more closely equalize the amount of light from each of the orders of diffraction, the 0 order; the +1, −1; the +2, −2; and the like. Light contained in the 0 order of the beam varies over a wide range and might vary within the range of 50%-99% of the total light passing through the collimating lens assembly 125 to be reflected by second optical mirror 116 towards the camera 124. The amount of light in the zero order depends on the number of factors, such as the brightness of the laser diode, the type of subject being imaged and other factors. In the most common situations, the percentage of light in the zero order is between 90% and 98% of the total light, though amounts in the range of 85% to 95% are quite common as well. The light in the first order diffraction, +1 and −1, combined will often equal approximately 7%-12% of the total light passing through the collimating lens assembly 125, with an amount in the range of 8%-10% being the most common. The amount of light in the next order of diffraction, +2 and −2, is usually about half the amount in the first order, so if the first order is in the 10% range, the second order will be in the 5% range; if the first order is in the 6%-8% range, the second order will be in the 3%-4% range. The amount of light in the +3 and −3 order of diffraction will usually be about half that in the second order, so that if the second order is in the 4%-5% range, the third order will have an amount of light in the 2%-2.5% range. In cases in which a large amount of the light, such as 95%, is contained in the zero order, the amount of light in the first order is in the range of 3% so that the third order is commonly in the range of less than 1%, of the total light passing through the collimating lens assembly 125.

Accordingly, the inventive filter 155 attenuates each of the orders of diffraction based on its initial strength of that the order so as to equalize all orders to be approximately equal to a selected order, for example, the +2, −2 order or the +3, −3 order, as desired.

In the embodiment shown in FIG. 6D a spatial filter is shown that will normalize the zero and first order light received to that of the second order. In this example, 90% of the light is in the zero order, about 5.5% of the light is in the first order, and about 2.7% of the light is in the second order. The central region 156 will be aligned with the 0 order beam and have an opacity selected to absorb approximately 97% of the light in the zero order and thus attenuate the light such that approximately 2.6%-2.7% of the amount of light in the 0 order passes therethrough to be received by the camera 124. The next range of the filter 157 is aligned with the +1 and −1 orders and is designed to have an opacity of about 50%, namely, approximately 50% transmissive and 50% opaque so as to absorb about 50% of the light and permit 50% of the light in the +1, −1 order to pass therethrough. The next filter portion 158 will be generally aligned with the +2, −2 order of diffraction beam and will not attenuate the light image in this region. Thus, about 2.6%-2.7% of the total light will be passed through from the +1 and −1 orders. It will allow all of the light in the +2, −2 order to pass without attenuation for this order of diffraction. The remainder of the filter 155 will also be completely transparent in order to permit all light from the remaining orders, +3, −3; +4, −4 to pass therethrough unattenuated. Accordingly, light from all orders of diffraction are able to be recorded by camera 124 to achieve a complete hologram in the visual section. The image information will, therefore, be obtained from each of the orders of diffraction, from zero order through at least the fourth order so that the entire hologram can be recorded. Thus, an image of the picture of the hologram itself is recorded in camera 124 which includes all orders of diffraction above the second order equalized to the second order for recording by the camera 124.

The filter 155 may have one, two, three, four or more attenuation filters, depending on the order to which the light will be equalized. Thus, the filter may attenuate all light to be equal to the +3, −3 order intensity, the +4, −4 order intensity or the like. The use of the graduation attenuation filter 155 provides the advantage that more hologram information can be recorded by the camera 124 than previously available in any attempts of the prior art.

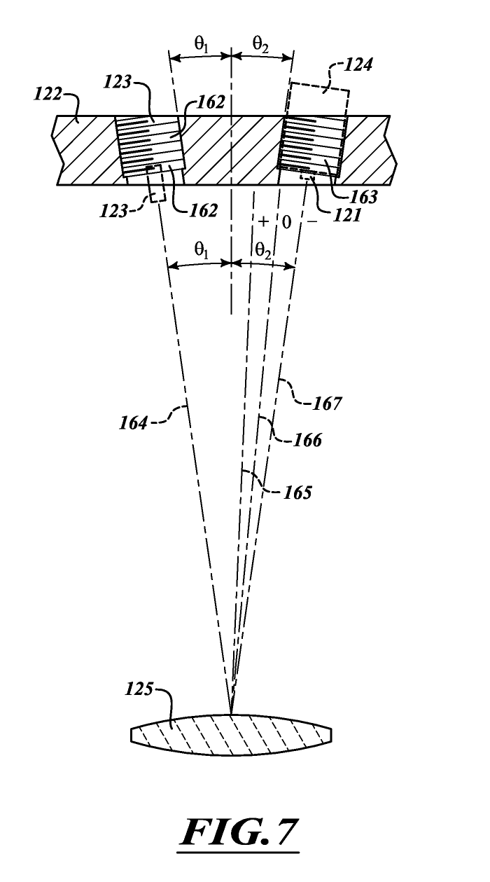

FIG. 7 illustrates one alternative embodiment for the structure of the translation stage 122. In the first embodiment, shown in FIG. 3C, the stage 122 is flat. In the second embodiment of FIG. 7, translation stage 122, the light source 123 and the camera 124 are mounted on a translation stage with an angle of tilt. This provides the advantage that both the light source and the camera move as a unit and any movement made to position either of them will also move the other one so that the two remain an exact distance in exact relationship with respect to each other. In the prior art, as best illustrated in U.S. Pat. No. 5,179,455, the light source 74 was mounted directly on the translation stage 96; however, the camera was mounted at a different location and movement of the stage did not cause movement of the camera, thus, slightly distorting the recorded image requiring multiple calibrations and adjustments to overcome. An advantage is therefore obtained by having both the camera and the light source on the same translation stage 122.

Having both the camera and the light source on the same translation stage 122 creates the issue that each of them will be slightly off axis from the center axis and neither will be exactly perpendicular to the collimating lens assembly 125 they face.

FIG. 7 illustrates an embodiment in which the translation stage contains tilted apertures to match the optical angle with respect to the collimating lens assembly 125 so that each of them is exactly perpendicular at their respective location with respect to light coming from collimating lens assembly 125. Specifically, the translation stage 122 in this embodiment contains a first aperture 162 tilted at a slight angle θ₁ to receive the light source 123 and another aperture 163 tilted at a slight angle θ₂ to receive the optical spatial filter 121 (which serves as the camera aperture). Both recess holes are angled from the normal by angles θ₁ for the laser diode 123 and angle θ₂ for the optical spatial filter 121.

Turning first to the light source 123, the angle θ₁ is specifically selected to emit a laser light beam 164 that will be exactly perpendicular to the face of the collimating lens assembly 125 based on the distance that the light source is from the center line of the plate 122. The details of the laser diode generation structure 123 are not shown in FIG. 7 for ease of illustration, however, the laser light beam 164 is preferably in a circular shape after having passed through a conditioning filter of the type shown in FIGS. 5B and 5C, though this is not required and a beam of the type of FIG. 5A could also be used.

In a preferred embodiment, the plate 122 is approximately ½″ thick and has a diameter in the range of 7″-8″. Accordingly, the distance of the laser diode 123 from the center of plate 122 may be in the range of 0.5″-2.5″. The angle θ₁ will therefore be selected based on the actual distance as compared to the size of the plate and based on the size and relative distance to the collimating lens assembly 125. The angle θ₁ may be in the range of 0.5°-3°, but this value will vary depending on the dimensions of the housing 115 and the various components therein.

Similarly, the aperture 163 is tilted slightly so as to place the optical spatial filter 121 at a slight angle relative to the exact horizontal at the front plane of translation stage 122. The angle θ₂ is selected based on the distance from the central axis of the translation plate 122 to the optical spatial filter 121 to align the light entering the optical spatial filter 121 to be exactly perpendicular to the filter itself. This alignment provides the advantage of even light intensity passing through the optical spatial filter 121 at all angles and assists to normalize the amount of light passing through the filter for each of the various orders for recording by the camera 124. The distance, depending on the size of the camera and the size of the plate, may be exactly equal to that of the light source so the two apertures are symmetrical to each other, as in the embodiment shown in FIG. 7. Alternatively, the distances do not need to be equal and the angles do not need to be the same as each other since they will be based on the respective distances from the center plane 161. Accordingly, in some embodiments, the angle θ₂ may be in the range of 0.5°-3°. The respective apertures 162, 163 are tilted to closely match to the perpendicular of the incident beam that will pass through the collimating lens assembly 125 in order to provide more accurate recording of the optical image of the hologram.

One embodiment for making the tilted apertures is to drill holes in the plate 122 at the desired angle, tap the drill holes to a distance just over halfway through the plate 122 so as to create threads into which a bracket assembly holding the respective laser diode 123 and optical spatial filter 121 which may be inserted against the apertures 162 and 163. The apertures 162 and 163 holding the light source 123 and optical spatial filter 121 contain a flange at the outer edge that abut the threads of the aperture in the plate 122. The optical tools 123 and 121 may be mounted on brackets and threaded into the plate 122 and stop on the respective apertures 162 and 163.

Once the camera 124 is mounted to the plate 122, the plate may be moved to align the spatial filter 121 with the appropriate order. As shown in FIG. 7, the spatial filter 121 is aligned with the −1 order beam 167. The light contained in the zero beam 166 will be blocked, as will all other beams of light. The stage 122 can be moved to align the spatial filter 121 with the zero order beam 166 or the +1 order beam 165. The spacing of the beams 165, 166 and 167 with respect to each other is not shown to scale in FIG. 7 for ease of illustration; in reality, the beams will be much closer to each other so that all will impact on the spatial filter 121 at the same time; FIG. 7 shows them with enlarged spacing for improved illustration of three separate beams being present. Of course, the light coming from lens assemble 125 will include many other orders, such as the +2, −2; +3, −3, etc. and these are not shown for simplicity. The movement required of the translation stage 122 will therefore be very small to aligned the spatial filter 121 with the desired optical order of the light.

The particular spatial filter 121 used can be any one of the filters selected from those shown in FIGS. 6A-6D and others as described herein. In one embodiment, each of the filters shown in FIGS. 6A-6D are provided and the in image is recorded with each. The four filters are placed in a changeable mechanism, such as a rotating disk, with one filter in each quadrant of the disk. According to one embodiment, a first set of images are recorded with the filter of 6A in place, then it is replaced with the filter of FIG. 6B, then it is replaced with the filter of 6C, then it is replaced with the filter of 6D. Thus, four sets of images are recorded and the physician can access all of the sets of images to performed the medical diagnosis. This embodiment of the changeable optical spatial filter therefore provides significant advantageous in being able to obtain a large array of images over a short time period and provide the medical professional a large amount of data to study to aid in treatment of the patient.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. An apparatus comprising:
a first acoustic transducer positioned to transmit sampling acoustic waves through an object to be examined;
an acoustic receiving tank positioned to receive the sampling acoustic waves after they have passed through the object to be examined;
a second acoustic transducer positioned to transmit reference acoustic waves that will combine with the sampling acoustic waves after they have passed through the object to be examined to create an acoustic hologram;
an acoustic hologram detection surface positioned to received the combined with the combined sampling acoustic wave and the reference acoustic wave;
a single piece cast housing positioned adjacent the hologram detection surface, the single piece cast housing having a first coupling surface positioned to receive an optical lens housing, and a second coupling surface positioned to receive an optical imaging assembly.

2. The apparatus according to claim 1 wherein the housing further includes:
a third coupling surface positioned on the housing to receive first reflective mirror; and
a fourth coupling surface positioned on the housing to receive a second reflective mirror.

3. The apparatus according to claim 1 wherein the housing is “U” shaped having the lens receiving surface positioned adjacent to the optical imaging assembly.

4. The apparatus according to claim 1 wherein the optical imaging assembly comprises a light generation source and a light receiving assembly.

5. The apparatus according to claim 1 further including:
a spatial filter position between the light receiving assembly and the lens, the spatial filter having a region positioned to block substantially all of the light at first selected locations and a region positioned to pass substantially all of the light at second selected locations.

6. The apparatus according to claim 1 further including:
a lens assembly coupled to the first coupling surface, the lens assembly having a housing with a first coupling surface to mate with the first coupling surface of the single piece cast housing and a lens positioned inside the housing at a precise, predetermined distance from the first coupling surface of the housing.

7. The apparatus according to claim 6 wherein the lens assembly includes three separate lenses positioned adjacent each other in alignment that requires the light to pass through each of them in series.

8. The apparatus according to claim 7 wherein each of the lenses is comprised of a different material and each has an index of refraction that is different from the others.

9. The apparatus according to claim 8 wherein the first lens has an index of refraction within the range of 1.62 to 1.90, the second lens has an index of refraction within the range of 1.00 and 1.05 and the third lens has an index of refraction between 1.42 and 1.59.

10. The apparatus according to claim 9 wherein the first lens has an index of refraction within the range of approximately 1.8, the second lens has an index of refraction approximately 1.00 and the third lens has an index of refraction of approximately 1.5.

11. A lens assembly adapted to receive laser light, the lens assembly comprising:
a housing having a first end and a second end;
a first lens positioned in the housing and fixed a selected distance from the first end, the first lens being made of a material having an index of refraction within the range of 1.42 to 1.59;
a second lens positioned in the housing and abutting the first lens, the second lens having an index of refraction within the range of 1.00 to 1.01;
a third lens positioned in the housing and abutting the second lens, the third lens having an index of refraction within the range of 1.62 to 1.9.

12. The lens assembly according to claim 11 wherein the first lens is composed of a type of flint glass, the second lens is composed of a gas and third lens is composed of a type of crown glass.

13. The lens assembly according to claim 12 wherein the gas of the second lens is ambient air.

14. An optical spatial filter comprising:
a central region having an optical opacity within the range of 95% to 99%;
a doughnut region surrounding the central region, the doughnut region having an optical opacity within the range of 40%-60%;
a light transmissive region surrounding the doughnut region, the light transmissive region having an optical opacity within the range of 0% to 10%.

15. The optical spatial filter of claim 14 further including:
a partial light transmissive region positioned between the doughnut region and the light transmissive region, the partial light transmissive region having an optical opacity between 10% and 30%

16. A laser light output assembly comprising:
a laser diode composed of a plurality of layers of semiconductor material;
a light input lens positioned adjacent the laser diode, the light input lens being circular in shape;
a transmission path position adjacent the round optical lens; and
a light output lens positioned adjacent the light transmission path, the light output lens being circular in shape.

17. The laser light output assembly of claim 16 further comprising:
a plurality of prisms positioned in the light transmission path between the light input lens and the light output lens, the prisms being arranged to modify the laser light beam shape into a circular pattern.

18. The laser light output assembly of claim 16 further including a round fiber optic cable positioned in the transmission path between the light input lens and the light output lens.

19. A method of recoding an acoustic hologram as an optical image comprising:
passing sound waves through a object to be examined;
creating an acoustic hologram pattern on a detection surface, the pattern having acoustic waves that have passed through the object combined with reference acoustic waves;
passing light generated by a laser diode through a transmission path, onto a first mirror, onto a second mirror and through an optical lens to impinge upon the hologram detection surface;
sensing the light that is reflected from the hologram detection surface; and
recording an image of the sensed light.

20. The method according to claim 19 further including:
passing the reflected light through a spatial optical filter to block all light in the zero order diffraction before recoding the image.

21. The method according to claim 19 further including:
passing the reflected light through a spatial filter that blocks over 90% but less than 99% of the light from the zero order diffraction, over 40% but less than 60% of the light from the first order diffraction and that passes at least 80% of the light from each of the second, third and fourth order diffractions.

22. A method of making an optical assembly for recording an acoustic hologram comprising:
casting a single piece metal housing in a mold;
machining selected portions of the cast metal housing to obtain precision surfaces spaced a precise distance apart from each other;
affixing a first mirror to a first machine surface of the single piece housing;
affixing a second mirror to a second machine surface;
affixing an optical plate to a third machined surface;
affixing an optical lens that is positioned in machined housing to the optical plate; and
affixing a light recording assembly to the optical plate.

23. The method of claim 22, wherein the light recording assembly also includes a laser light generation assembly and the step of affixing a light recording assembly to the optical plate further includes the step of:
affixing a light support plate that includes a light generating laser diode mounted on the same housing the light recording assembly.
